(19) United States
(12) Patent Application Publication
(10) Pub. No.: US 2026/0208330 A1
(43) Pub. Date: Jul. 23, 2026

(54) MINIATURE BENDING HAND TOOL

(71) Applicant: Bobby Hu, Taichung City (TW)

(72) Inventor: HSIEN-CHIH HU, Taichung City (TW)

(21) Appl. No.: 19/171,388

(22) Filed: Apr. 7, 2025

(30) Foreign Application Priority Data
Jan. 22, 2025 (TW) 114102698

(51) Int. Cl. B25B 23/00

(52) U.S. Cl. CPC B25B 23/0028; B25B 23/0035

(57) ABSTRACT

A miniature bending hand tool includes a short rod, a long rod, and an auxiliary member. The short rod has a combining part along a first axis. The combining part has a ¼-inch first tool hole. The long rod has a driving part along a second axis. The driving part has a 4-millimeter second tool hole and a combining outer periphery for combining a wrench. The short rod and the long rod are pivotally connected and switchable between a first and a second operational positions. At the first operational position, the first axis and the second axis are coaxially arranged. At the second operational position, the first axis and the second axis intersect to form a high-torque operational angle. The auxiliary member is engaged with the first or the second tool holes, thereby meeting different operational demands with suitable working ends of tool.

### BACKGROUND OF THE DISCLOSURE

### 1. Field of the Disclosure

The present disclosure relates to hand tools, and more particularly, to a multifunctional miniature bending hand tool.

### 2. Description of the Related Art

With increasing diversity of work requirements in the application of hand tools, higher flexibility and versatility of hand driving tools are expected. However, existing driving tools are often designed for one core purpose, unable to meet the continuously-changing usage scenarios, and typically only suitable for specific types of fasteners or operational requirements, lacking flexibility and adaptability.

If a user needs to perform different works or handle various types and sizes of objects, the user needs to carry multiple specialized hand tools for handling each task, not only increasing the burden of carrying and storing hand tools, but also lowering operational efficiency.

To resolve the issues above, US20080196559A1 discloses a multi-purpose driving tool, which comprises a first end having a fastener driver housing device for receiving a fastener driver device; a second end having a tool receiving device for receiving functional driving device or functional attachment; and a pivot point located between the first end and second end; wherein the first end and the second end pivot with respect to each other.

However, the aforementioned patent is only capable of connecting different tool heads by both ends thereof, with relatively simple operational functions, unable to effectively meet multifunctional operation requirements.

### SUMMARY OF THE DISCLOSURE

To improve the issues above, the present disclosure provides a miniature bending hand tool selectively connecting tool heads and screwdriver heads with different sizes and combining auxiliary members or wrenches through the short rod or the long rod based on different usage requirements, so as to achieve multifunctional operations.

For achieving the aforementioned objectives, an embodiment of the miniature bending hand tool comprises:
a short rod having a combining part and a first connecting part disposed away from the combining part arranged along a first axis, with a first tool hole concavely formed on an end surface of the combining part, the first tool hole having a sectional face formed in a hexagonal shape, a diameter of the first tool hole being a quarter of an inch;
a long rod having a driving part and a second connecting part disposed away from the driving part arranged along a second axis, with a second tool hole concavely formed on an end surface of the driving part, the second tool hole having a sectional face formed in a hexagonal shape, a diameter of the second tool hole being 4 millimeters, the driving part comprising a combining outer periphery having a profile formed in a hexagonal shape, the combining outer periphery of the driving part configured to be combined with a wrench, wherein the second connecting part of the long rod is pivotally connected with the first connecting part of the short rod, such that the long rod and the short rod switch between a first operational position and a second operational position; at the first operational position, the first axis and the second axis are disposed in a coaxial arrangement; at the second operational position, the first axis and the second axis intersect to form a high-torque operational angle; and
an auxiliary member detachably engaged with the first tool hole of the short rod or the second tool hole of the long rod.

With such configuration, the present disclosure is allowed to connect tool heads or screwdriver heads with different sizes through the first tool hole or the second tool hole, or engaged with the auxiliary member through the first tool hole or the second tool hole for performing an extension operation or high-speed rotation operation, achieving a multifunctional operational mode.

Also, the present disclosure is switchable between the first operational position and the second operational position through the adjustment of the short rod and the long rod, meeting operational requirements with different torque needs.

### BRIEF DESCRIPTION OF THE DRAWINGS

FIG. 1 is a perspective view of the miniature bending hand tool in accordance with an embodiment of the present disclosure, illustrating the short rod and the long rod at the first operational position, with the auxiliary member mounted around the long rod.

FIG. 2 is an exploded view of the miniature bending hand tool in accordance with an embodiment of the present disclosure.

FIG. 3 is a cross-sectional view taken along line A-A in FIG. 1, illustrating the short rod and the long rod at the first operational position.

FIG. 4 is a sectional view of the miniature bending hand tool in accordance with an embodiment of the present disclosure, illustrating the short rod and the long rod at the second operational position.

FIG. 5 is a sectional view of the miniature bending hand tool in accordance with an embodiment of the present disclosure, illustrating the short rod and the long rod at the first operational position, with the first tool hole of the short rod mounted around a tool head, and the second tool hole of the long rod engaged with the auxiliary member.

FIG. 6 is a sectional view of the miniature bending hand tool in accordance with an embodiment of the present disclosure, illustrating the short rod and the long rod at the first operational position, with only the first tool hole of the short rod mounted around the tool head.

FIG. 7 is a sectional view of the miniature bending hand tool in accordance with an embodiment of the present disclosure, illustrating the short rod and the long rod at the first operational position, with the first tool hole of the short rod engaged with the auxiliary member, and the second tool hole of the long rod mounted around the screwdriver head.

FIG. 8 is a perspective view of the miniature bending hand tool in accordance with an embodiment of the present disclosure, illustrating the short rod and the long rod at the first operational position, with the short rod mounted around the tool head, and the long rod engaged with the wrench.

FIG. 9 is a perspective view of the miniature bending hand tool in accordance with an embodiment of the present disclosure, illustrating the short rod and the long rod at the second operational position, with the short rod mounted around the tool head, and the long rod mounted around the screwdriver head.

FIG. 10 is a perspective view of the miniature bending hand tool in accordance with an embodiment of the present disclosure, illustrating the short rod and the long rod at the first operational position, with the short rod mounted around the tool head, and the long rod mounted around the auxiliary member for performing a high-speed rotation operation.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

The directional terms of, for example, “up”, “down”, “front”, “rear”, “left”, “right”, “inner”, “outer”, and “side” are only used herein for illustrating the relative directions shown in the drawings. Therefore, the directional terms are applied for the purpose of illustration and understanding of the present disclosure, instead of limiting the present disclosure.

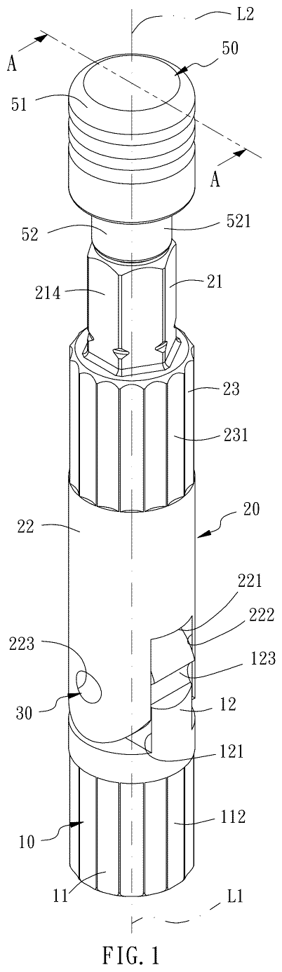

Referring to FIG. 1 to FIG. 10, the present disclosure provides a miniature bending hand tool, which is formed in a lightweight and easily carried pen shape. The miniature bending hand tool comprises a short rod 10, a long rod 20, and an auxiliary member 50.

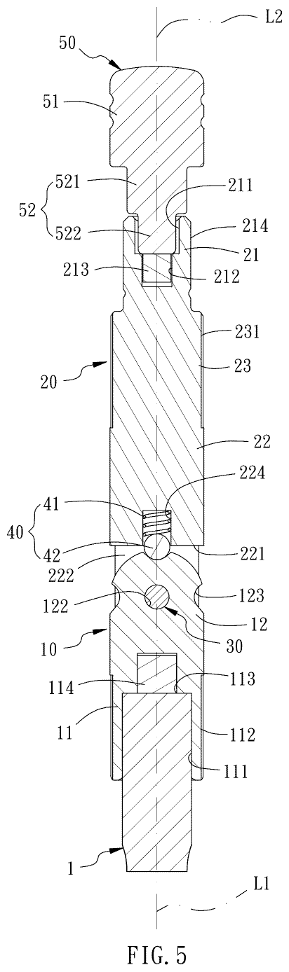

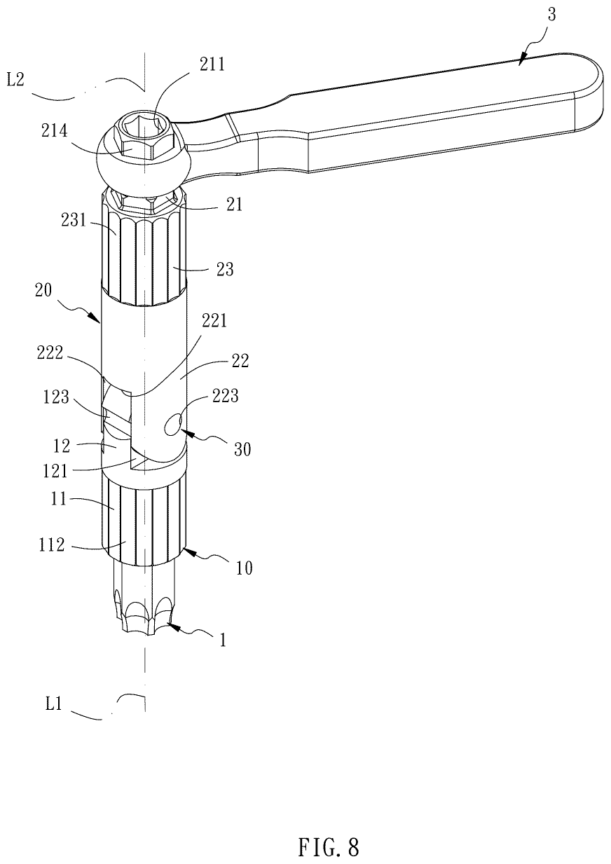

The short rod 10 has a combining part 11 and a first connecting part 12 disposed away from the combining part 11 arranged along a first axis L1. The combining part 11 has a first tool hole 111 concavely formed on an end surface thereof. The first tool hole 111 has a sectional face formed in a hexagonal shape, and the diameter of the first tool hole 111 is a quarter of an inch (¼ inch). Therein, the first tool hole 111 is allowed to be combined with a ¼-inch tool head 1, as shown by FIG. 5 and FIG. 8. The working end of the tool head 1 is allowed to be a cross-shaped, hexagon-shaped, dodecagon-shaped, flathead, star-shaped, Pozidriv, pentagonal-socket, hexagonal-socket, hexagonal ball head, snake eye, square head, tri-wing or swastika-shaped structure, and so on. Form of the working end of the tool head 1 is not limited by the present disclosure.

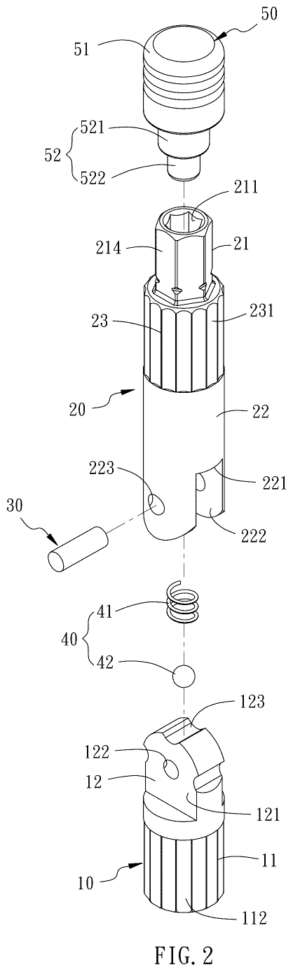

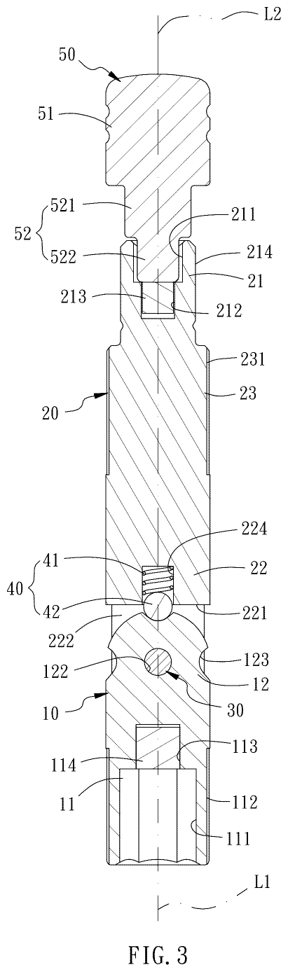

The combining part 11 has a plurality of first arc grooves 112 consecutively and concavely formed around the outer periphery thereof along the first axis L1, as shown by FIG. 1 and FIG. 2. The first tool hole 111 has a first receiving slot 113 concavely formed therein along the first axis L1, with a first magnetic member 114 embedded in the first receiving slot 113, as shown by FIG. 3 and FIG. 5. Therein, when the tool head 1 is combined to the first tool hole 111, the first magnetic member 114 attracts the too head 1 to achieve a quick assembly effect.

The first connecting part 12 comprises two position limiting faces 121 both formed in a plane shape and arranged in parallel to the first axis L1, with a first pivot hole 122 passing through the two position limiting faces 121. Therein, the first connecting part 12 has an arc-shaped distal end comprising a plurality of positioning grooves 123. In the embodiment, three positioning grooves 123 are provided, and the positioning grooves 123 are spaced 90 degrees apart from each other, as shown by FIG. 2 and FIG. 3.

The long rod 20 has a driving part 21 and a second connecting part 22 disposed away from the driving part 21 arranged along a second axis L2, with a middle part 23 integrally disposed between the driving part 21 and the second connecting part 22. The middle part 23 has a plurality of second arc grooves 231 consecutively and concavely formed around the outer periphery of the middle part 23 along the second axis L2, as shown by FIG. 1 to FIG. 3. Therein, the length of the short rod 10 is smaller than or equal to half the length of the long rod 20.

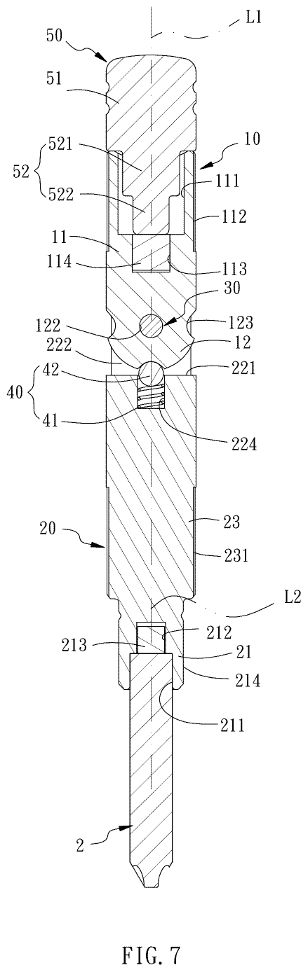

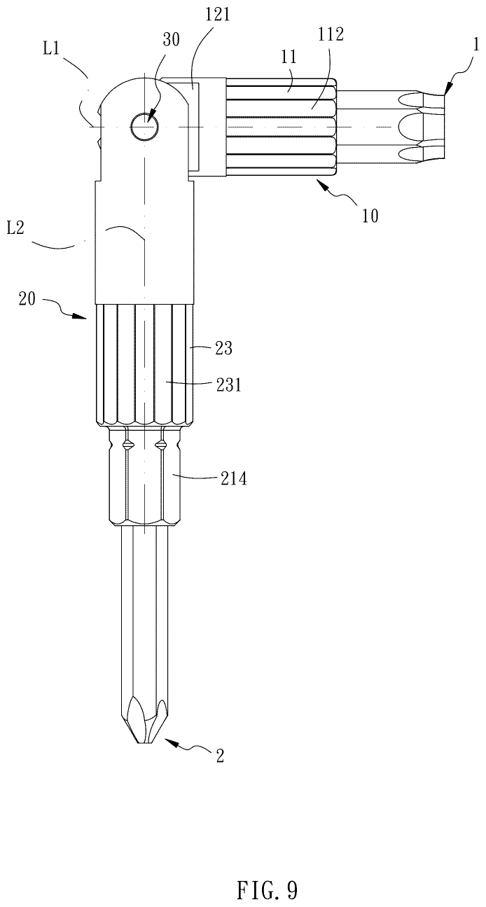

The driving part 21 has a second tool hole 211 concavely formed on an end surface thereof. The second tool hole 211 has a sectional face formed in a hexagonal shape, and the diameter of the second tool hole 211 is 4 millimeters. Therein, the second tool hole 211 is allowed to be combined with a 4-millimeter screwdriver head 2, as shown by FIG. 7 and FIG. 9. The working end of the screwdriver head 2 is allowed to be a cross-shaped, inner hexagonal-socket, flathead or star-shaped structure, and so on. Form of the working end of the screwdriver head 2 is not limited by the present disclosure.

The second tool hole 211 has a second receiving slot 212 concavely formed therein along the second axis L2, with a second magnetic member 213 embedded in the second receiving slot 212, as shown by FIG. 3 and FIG. 7. Therein, when the screwdriver head 2 is combined to the second tool hole 211, the second magnetic member 213 attracts the screwdriver head 2 to achieve a quick assembly effect.

The driving part 21 comprises a combining outer periphery 214 having a profile formed in a hexagonal shape. The combining outer periphery 214 of the driving part 21 is configured to be combined with a wrench 3, so as to provide an operational mode capable of imposing a larger force, as shown by FIG. 8. Therein, in the embodiment, the outer diameter of the combining outer periphery 214 is a quarter of an inch, and the wrench 3 is a ratchet wrench.

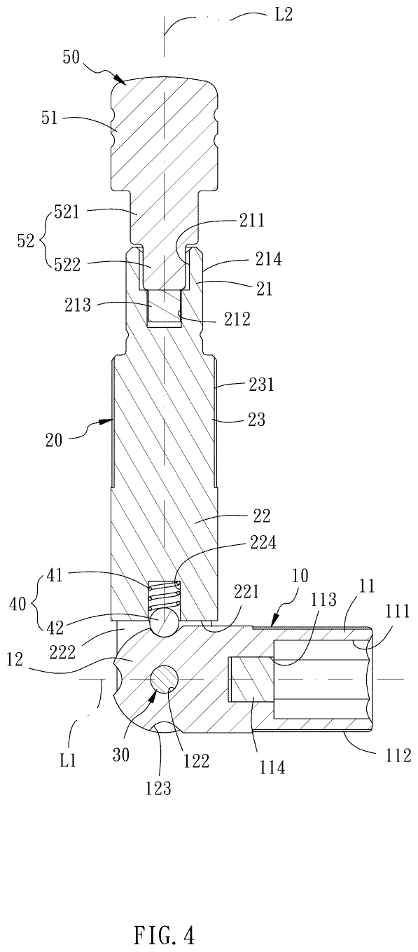

Also, the second connecting part 22 of the long rod 20 has a concave pivot groove 221. The pivot groove 221 comprises two inner groove faces 222 formed in a plane shape and arranged in parallel to the second axis L2, with a second pivot hole 223 passing through the two inner groove faces 222. When the first connecting part 12 of the short rod 10 is disposed in the pivot groove 221, the two position limiting faces 121 and the two inner groove faces 222 are disposed in a face-to-face arrangement, wherein a pivot pin 30 passes through the first pivot hole 122 of the first connecting part 12 and the second pivot hole 223 of the second connecting part 22, such that the short rod 10 and the long rod 20 are pivotally combined by the pivot pin 30, whereby the long rod 20 and the short rod 10 switch between a first operational position (as shown by FIG. 3) and a second operational position (as shown by FIG. 4).

Also, a positioning assembly 40 is disposed between the first connecting part 12 of the short rod 10 and the second connecting part 22 of the long rod 20, allowing the short rod 10 and the long rod 20 to be positioned at a high-torque operational angle. Therein, referring to FIG. 2 to FIG. 4, the pivot groove 221 comprises a third receiving slot 224 therein along the second axis L2. The positioning assembly 40 comprises an elastic member 41 and a positioning detent 42, with two ends of the elastic member 41 abutting against the bottom part of the third receiving slot 224 and the positioning detent 42. The elastic member 41 pushes the positioning detent 42 into one of the positioning grooves 123. In the embodiment, the high-torque operational angle is 90 degrees.

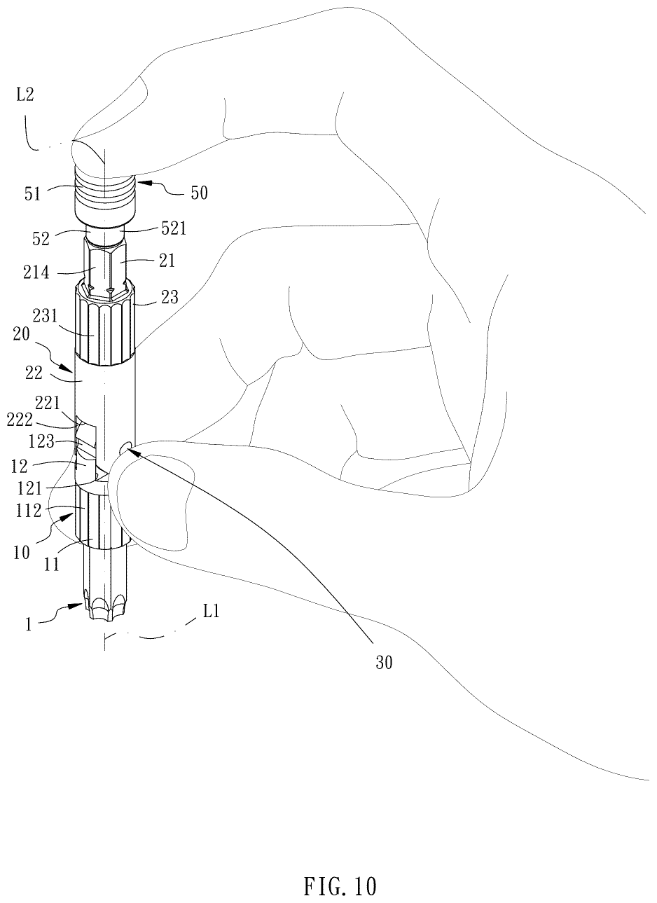

The auxiliary member 50 is detachably engaged with the first tool hole 111 of the short rod 10 or the second tool hole 211 of the long rod 20. Therein, the auxiliary member 50 is able to serve as an extension member for increasing the length of the short rod 10 or the long rod 20, facilitating a smoother operation. Alternatively, referring to FIG. 10, the auxiliary member 50 is engaged with the long rod 20, with the tool head 1 combined with the short rod 10, such that the user grips the miniature bending hand tool with fingers, and rest the index finger against the auxiliary member 50, facilitating a quick rotation of the miniature bending hand tool, thereby achieving a high-speed driving purpose and effect.

Also, the auxiliary member 50 comprises a main body 51 and an engagement part 52 extending from the main body 51. The engagement part 52 is formed in a step shape, comprising a large diameter section 521 and a small diameter section 522, wherein the large diameter section 521 is connected between the small diameter section 522 and the main body 51. The engagement part 52 is able to be received in the first tool hole 111 (as shown by FIG. 7), and the small diameter section 522 is able to be received in the second tool hole 211 (as shown by FIG. 5). The length of the first tool hole 111 on the first axis L1 is equal to the length of the engagement part 52, and the length of the second tool hole 211 on the second axis L2 is equal to the length of the small diameter section 522. Therein, when the engagement part 52 is received in the first tool hole 111, the small diameter section 522 is attracted to the first magnetic member 114; when the small diameter section 522 is received in the second tool hole 211, the large diameter section 521 is exposed from the second tool hole 211, and the small diameter section 522 is attracted to the second magnetic member 213.

In view of the structural illustration of the embodiment of the present disclosure, referring to FIG. 5, at the first operational position, the first axis L1 and the second axis L2 are disposed in an coaxial arrangement. The first tool hole 111 is combined with the ¼-inch tool head 1 and attracted to the first magnetic member 114, with the auxiliary member 50 engaged with the second tool hole 211 of the long rod 20, so as to be used to perform a normal driving operation or a high-speed rotating mode operation as shown by FIG. 10.

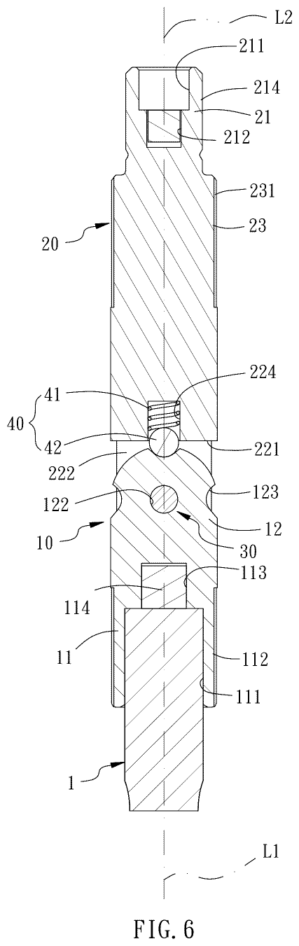

Referring to FIG. 5 and FIG. 6, under certain conditions, the present disclosure is used without the auxiliary member 50 to perform a normal driving operation.

Referring to FIG. 7, under certain conditions, at the first operational position, the second tool hole 211 is combined with the 4-millimeter screwdriver head 2 and attracted to the second magnetic member 213, with the auxiliary member 50 engaged with the first tool head 111 of the short rod 10.

Referring to FIG. 9, at the second operational position, the first axis L1 and the second axis L2 intersect to form a high-torque operational angle; the short rod 10 is mounted around the tool head 1, the long rod 20 is mounted around the screwdriver head 2, and the length of the short rod 10 serves as the force imposing arm to achieve a high-torque driving operation. Under certain conditions, the length of the long rod 20 is also allowed to serve as a force imposing arm to achieve a high-torque driving operation as well, as shown by FIG. 4.

With the foregoing configuration, advantages of the present disclosure will be illustrated below.

The miniature bending hand tool is allowed to use the first tool hole 111 of the short rod 10 or the second tool hole 211 of the long rod 20 to connect differently sized tool heads 1 or screwdriver heads 2 or the auxiliary member 50, so as to perform a high-speed rotation operation, achieving a multifunctional operation.

The short rod 10 and the long rod 20 of the miniature bending hand tool are adjustable between the first operational position and the second operational position to fulfill different operational torque requirements.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A miniature bending hand tool, comprising:
a short rod having a combining part and a first connecting part disposed away from the combining part arranged along a first axis, with a first tool hole concavely formed on an end surface of the combining part, the first tool hole having a sectional face formed in a hexagonal shape, a diameter of the first tool hole being a quarter of an inch (¼ inch);
a long rod having a driving part and a second connecting part disposed away from the driving part arranged along a second axis, with a second tool hole concavely formed on an end surface of the driving part, the second tool hole having a sectional face formed in a hexagonal shape, a diameter of the second tool hole being 4 millimeters, the driving part comprising a combining outer periphery having a profile formed in a hexagonal shape, the combining outer periphery of the driving part configured to be combined with a wrench, wherein the second connecting part of the long rod is pivotally connected with the first connecting part of the short rod, such that the long rod and the short rod switch between a first operational position and a second operational position; at the first operational position, the first axis and the second axis are disposed in a coaxial arrangement; at the second operational position, the first axis and the second axis intersect to form a high-torque operational angle; and
an auxiliary member detachably engaged with the first tool hole of the short rod or the second tool hole of the long rod.

2. The miniature bending hand tool of claim 1, wherein an outer diameter of the combining outer periphery is a quarter of an inch.

3. The miniature bending hand tool of claim 1, wherein the combining part has a plurality of first arc grooves consecutively and concavely formed around an outer periphery of the combining part along the first axis; the long rod comprises a middle part integrally connected between the driving part and the second connecting part; the middle part has a plurality of second arc grooves consecutively and concavely formed around an outer periphery of the middle part along the second axis.

4. The miniature bending hand tool of claim 1, wherein the auxiliary member comprises a main body and an engagement part extending from the main body; the engagement part is formed in a step shape and comprises a large diameter section and a small diameter section; the large diameter section is connected between the small diameter section and the main body; the engagement part is able to be received in the first tool hole, and the small diameter section is able to be received in the second tool hole.

5. The miniature bending hand tool of claim 4, wherein the first tool hole has a first receiving slot concavely formed therein along the first axis, with a first magnetic member embedded in the first receiving slot; the second tool hole has a second receiving slot concavely formed therein along the second axis, with a second magnetic member embedded in the second receiving slot; when the engagement part is received in the first tool hole, the small diameter section is attracted to the first magnetic member; when the small diameter section is received in the second tool hole, the large diameter section is exposed from the second tool hole, and the small diameter section is attracted to the second magnetic member.

6. The miniature bending hand tool of claim 5, wherein a length of the first tool hole on the first axis is equal to a length of the engagement part; a length of the second tool hole on the second axis is equal to a length of the small diameter section.

7. The miniature bending hand tool of claim 1, wherein the second connecting part of the long rod has a concave pivot groove; the first connecting part of the short rod is disposed in the pivot groove; the first connecting part of the short rod is pivotally connected with the second connecting part of the long rod by a pivot pin, with a positioning assembly disposed between the first connecting part of the short rod and the second connecting part of the long rod, such that the short rod and the long rod are positioned at a high-torque operational angle.

8. The miniature bending hand tool of claim 7, wherein a first pivot hole passes through the first connecting part, and a second pivot hole passes through the second connecting part, with the pivot pin passing through the first pivot hole and the second pivot hole.

9. The miniature bending hand tool of claim 8, wherein a plurality of positioning grooves are concavely disposed on a distal end of the first connecting part; the pivot groove comprises a third receiving slot therein along the second axis; the positioning assembly comprises an elastic member and a positioning detent, with two ends of the elastic member abutting against a bottom part of the third receiving slot and the positioning detent; the elastic member pushes the positioning detent into one of the positioning grooves.

10. The miniature bending hand tool of claim 9, wherein the high-torque operational angle is 90 degrees; a length of the short rod is smaller than or equal to half a length of the long rod.
